(19) United States
(12) Patent Application Publication
(10) Pub. No.: US 2025/0315399 A1
(43) Pub. Date: Oct. 9, 2025

(54) SCALABLE MESSAGING (NETWORKING LIKE) ENDPOINT FOR A PCIE FABRIC BASED ON PCIE ADDRESS ROUTING

(71) Applicant: Sony Interactive Entertainment Inc., Tokyo (JP)

(72) Inventor: NAGARAJAN SUBRAMANIYAN, San Mateo, CA (US)

(21) Appl. No.: 18/630,349

(22) Filed: Apr. 9, 2024

(51) Int. Cl. G06F 13/40; G06F 13/28

(52) U.S. Cl. CPC G06F 13/404; G06F 13/28; G06F 2213/0026

(57) ABSTRACT

Simple networking/messaging is implemented between PCIe endpoints that is scalable in a local area of systems connected by a PCIe fabric, using the features of PCIe and a DMA engine to implement a layer 2 switching equivalent with PCIe address routing. This provides a simple software stack for peer-to-peer communications between applications using a low latency PCIe fabric.

### FIELD

The present application relates generally to scalable messaging (Networking like) endpoints for a PCIe fabric based on PCIe address routing.

### BACKGROUND

As understood herein, in current PCIe fabric technology there is no peer-to-peer messaging or networking application support with a simple, scalable hardware and software stack, in contrast to an ethernet network. As also understood herein, attempting to address this using non-transparent bridging memory windows to implement a higher level messaging protocols entails several drawbacks, including use of a complicated software stack and limited networking functionality, failure to support multicast or broadcast options in hardware because a message must be replicated by every client software, and failure to scale well beyond eight or sixteen systems. Also, using non-transparent bridging memory windows to implement a higher-level messaging protocols is difficult to configure even with an out-of-band/in-band management software. Moreover, doorbells/interrupts are not automatic and have to be triggered by sender as a separate transaction that has several limitations (number of available doorbells/interrupts, number of interrupts/see at the destination). Moreover, security exposure is a concern in that local doorbells must be exposed to the fabric. Also, a doorbell is not tied to other resources (including memory) shared between the two peers and is a separate entity, requiring a management application to take several steps to connect the two peers for doorbell management of every queue shared between the two peers. Still further, peers appearing and disappearing (power up/down) are not well handled.

### SUMMARY

Present principles solve some or all the above issues with a simple hardware scheme that offloads peer to peer message traffic that includes unicast, multicast or broadcast messaging to the PCIe connected .fabric hardware. A simple hardware scheme presents a networking DMA interface over a PCIe fabric using PCIe and PCIe NTB features. This improves performance, response times, and simplifies software stack presenting a simple networking (NIC) interface to the local hosts.

An example environment in which present principles may be used is for computer game streaming servers.

Accordingly, a method includes mapping window segment addresses in a base address register (BAR) to respective peer networking IDs to establish a mapping, and storing the mapping. The method also includes updating, with the mapping, peers in a peer-to-peer network configured for communicating with each other over a peripheral computer interconnect express (PCIe). Further, the method includes, for a message to be sent from a transmitting peer to a destination peer, converting a network ID in the message to a corresponding destination window segment address using the mapping. The method additionally includes writing the message to the corresponding destination window segment address, while at the destination peer, placing the message from the corresponding destination window segment address into a receiving first in first out (FIFO) storage for further processing.

In some embodiments the method includes identifying a next receive queue pointer and performing direct mapping access (DMA) of the message in the FIFO storage to the receive queue. This may also include generating an interrupt event for receiving the message.

In non-limiting examples the BAR includes a BAR2.

In example implementations the mapping is stored in hardware of a fabric interface endpoint of the transmitting peer. The converting can be executed during processing a transmit queue descriptor.

In another aspect, a computer simulation streaming system includes at least a transmitting peer and a destination peer configured to communicate with each other through respective messaging direct memory access (DMA) endpoints through a peripheral computer interconnect express (PCIe) fabric. The endpoint of the transmitting peer includes at least one basic address register (BAR) memory mapped register space, at least one respective transmit descriptor queue (TXQ), at least one segmented memory window in BAR, and at least one direct mapping access (DMA) engine configured for controlling messages through the endpoint. The endpoint also includes at least one data structure stored in hardware of the endpoint to map media access code (MAC) addresses to respective PCI memory windows of the destination peer

The endpoint of the destination peer can include at least one receive buffer queue (RXQ), at least one segmented memory window in BAR, and at least one DMA engine configured for controlling messages through the endpoint. The DMA engine of the endpoint of the transmitting peer is configured to convert a destination peer address to a destination window segment address using the data structure stored in hardware to write at least a first message to the destination window segment address through the PCIe fabric.

In another aspect, a device includes at least a first computerized peer and at least a first direct mapping address (DMA) endpoint communicatively coupling the first computerized peer to at least one peripheral computer interconnect express (PCIe) fabric. The DMA endpoint includes at least one host side network interface and at least one fabric side network interface with at least one DMA engine therebetween. The DMA endpoint is configured for switching based on PCIe memory addresses associated with destination endpoints converted from network addresses instead of switching based on respective networking addresses of destination endpoints.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example environment;

FIG. 3 illustrates a high level architecture;

FIG. 4 illustrates a first example endpoint;

FIG. 5 provides further illustration of an endpoint;

FIG. 6 illustrates example logic in example flow chart format;

FIG. 7 illustrates an example endpoint in the context of multicast and broadcast messages; and

FIG. 8 illustrates an example gaming datacenter.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. Client devices also may include servers. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

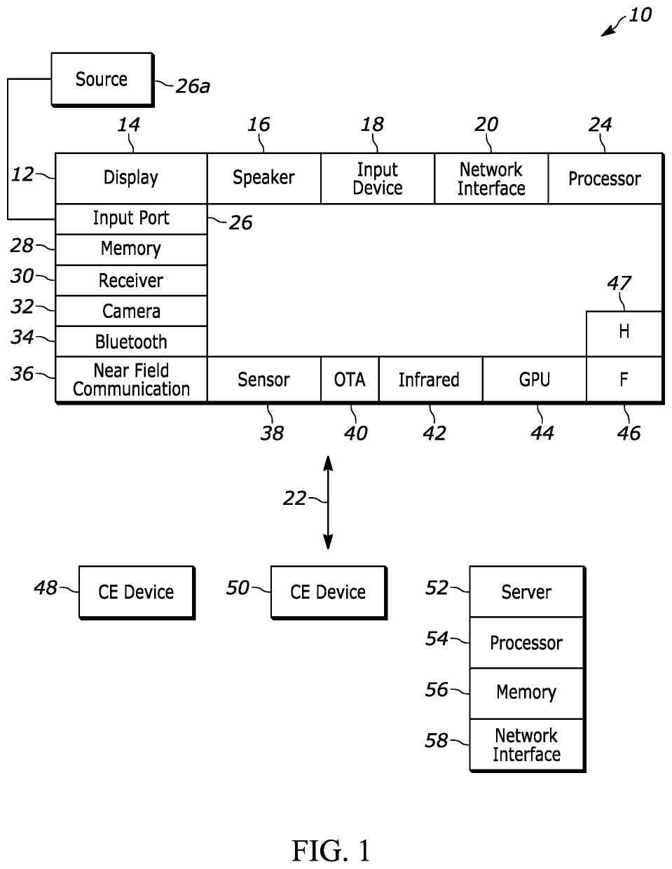

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

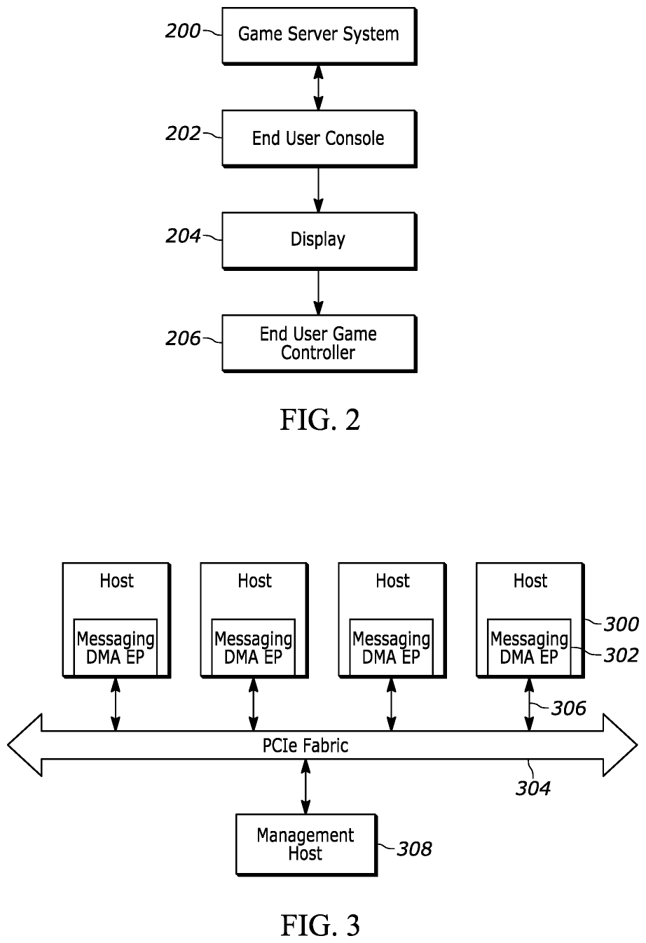

FIG. 2 illustrates an example environment in which present principles may be used. A computer simulation server system 200 such as a computer game server or servers communicates with one or more end user game consoles 202 and/or displays 204 to present computer simulations such as computer games on the display, if desired under control of a player manipulating an end user computer game controller 206. Present principles may be used to implement the server system 200.

Refer now to FIG. 3, which illustrates a rack level network of computer servers, referred to herein as “hosts” 300, each having a respective peripheral computer interconnect express (PCIe) messaging direct memory access (DMA) endpoint 302 connected to a PCIe fabric 304 via respective PCIe links 306. The links 306 may appear as non-transparent bridges to be enumerated, configured and managed by a management host 308 connected to the same PCIe fabric 304 as are the hosts 300. The fabric side can alternatively appear as a networking endpoint instead of a non-transparent bridge, which impacts only the software stack on the management host but offers the same functionality. Thus, present principles are based on a rack/row level PCIe fabric with each host connecting to the fabric using a non-transparent bridge. While each host is seeing a messaging/networking endpoint on its PCIe bus, the data between peers is done through a non-transparent memory windows on the PCIe fabric side, switching based on PCIe memory addresses instead of switching based on networking ID of the endpoints.

Present principles are directed to exploiting Ethernet principles in PCIe to be able to send messages including “doorbells” between the hosts 300 in various protocols through the fabric 304 while minimizing the number of messages required to be sent in software to all peer hosts by better scaling of the hardware described herein.

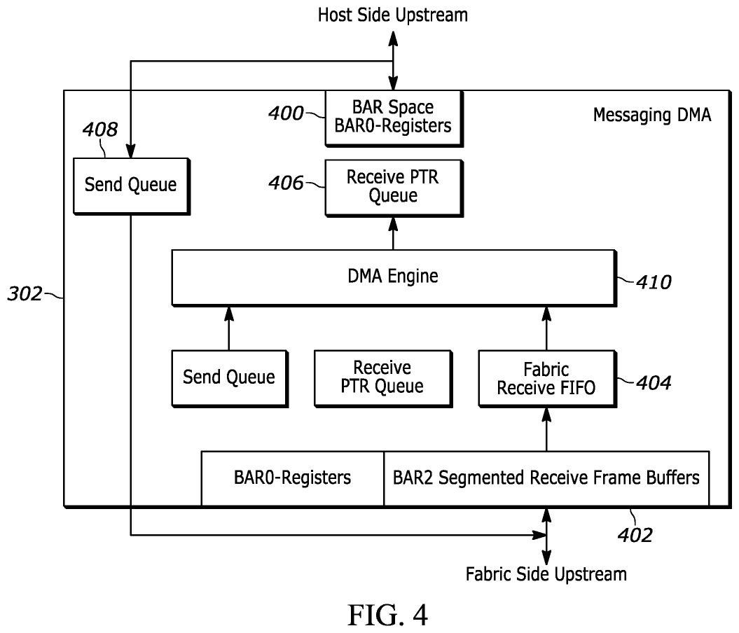

FIG. 4 illustrates details of a DMA endpoint 302 in FIG. 3. To achieve present principles, on both the host and fabric side of the endpoint 302, an ethernet style network interface 400 (host side) 402 (fabric side) is exposed using up to six 32-bit addresses or three 64 bit-addresses (basic address register ((BAR0, BAR2, BAR4) as windows into the device. Each BAR typically is a memory location that describes a memory region or window (base address+width) useful for communicating data. As discussed further below, tables in hardware map media access control (MAC) addresses to respective PCI memory windows, and multiple hosts 300 can write to one window in FIG. 3, queued in first in first out (FIFO) buffers 404. The endpoint 302 also may include receive queues 406 on the host and fabric sides and send queues 408 on the host and fabric side. A processor-implemented DMA engine 410 may coordinate message transmission.

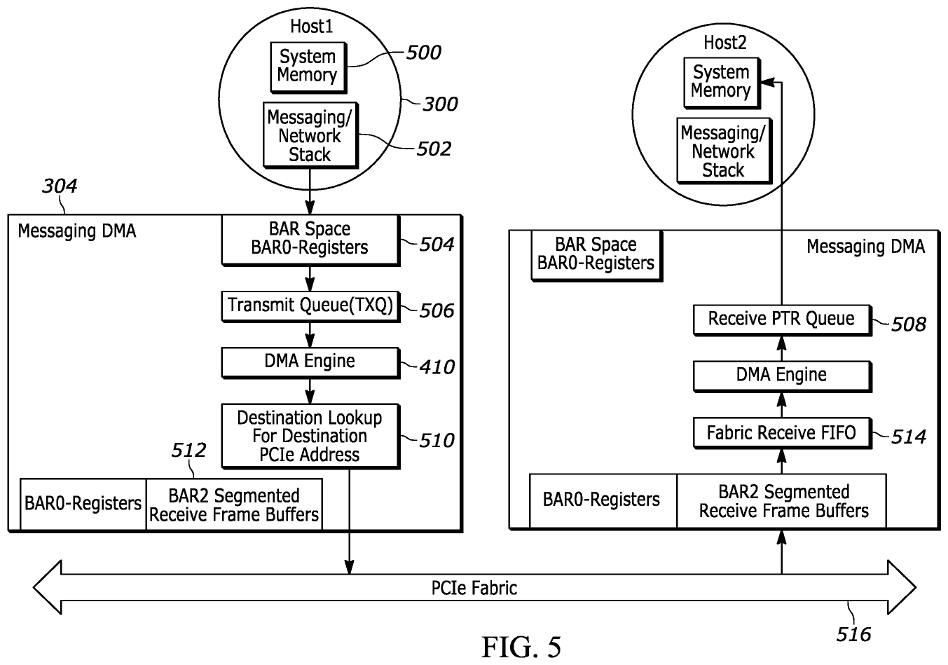

FIG. 5 illustrates two host peers 300 communicating with each other through respective messaging DMA endpoints 304. Each host 300 may include a respective system memory 500 and messaging/network protocol stack 502 interfacing with the respective endpoint 304 as shown.

In FIG. 5, transmission components of the endpoint on the left (of the host peer writing data) are shown while receive components of the endpoint on the right (target peer) are illustrated.

In the example of FIG. 5, each upstream portion of the endpoint 304 includes a BAR0 memory mapped register space 504. A set of MSI-x interrupts (errors, receives, transmit completions, etc.) may also be provided.

The transmission components of each endpoint also include a respective set of transmit descriptor queues (TXQ) 506 while the receive components include a set of receive buffer ptr queues (RXQ) 508. These queues can be implemented in hardware or software. Each networking endpoint is associated with a respective networking ID unique in the fabric (locally administered or hard coded). As discussed above, each endpoint includes tables 510 in hardware such as a solid state storage that map media access code (MAC) addresses to respective PCI memory windows of the receiver.

The fabric side of each endpoint includes a respective segmented memory window in BAR2 512 (termed “segmented receive frame buffers” in FIG. 5) similar to a non-transparent bridge endpoint. Memory segments may be used. Memory segments can be allocated as a power of two multiple of 4 KB. The size of memory window segment may be chosen such that it should accommodate the maximum possible frame size of a single message. PCIe alignments and typical computer system memory page sizes dictate a minimum of 4 KB for a window segment, even if a messaging frame is expected to be less than 4 KB.

Software in the management host 308 shown in FIG. 3 maps the window segments such that there is one segment per peer networking ID. Management software is also responsible for updating all peers with these mappings. Every peer host has a window segment for it in the other peer participating in the PCIe fabric.

The DMA engine 410 of each endpoint can process a transmit queue descriptor, converting the destination peer address to a destination window segment address and writing to that PCIe fabric address (a PCIe write using transmission layer packet (TLP) to that address with the message as TLP payload). The conversion may be done according to the mapping in the respective lookup table 510 of the endpoint. Then, a messaging frame that arrives at a window segment from a remote peer is stored to a RX FIFO 514 by the DMA engine 410 of the receiving peer. The DMA engine 410 takes the next RXQ pointer of the messaging frame from the RXQ 508 and does DMA of the FIFO entry to the RXQ buffer of system memory in the local host 300 upstream, generating an interrupt event for receiving data. Note that messages from peer-to-peer travel through a PCIe fabric 516.

Note further that the management host 308 in FIG. 3 can always send and receive packets to the other side host through its transmit (TXQ) and receive (RXQ) queues without the need for the above address translation of destination networking ID, as the TXQ/RXQ of management host side endpoint is dedicated queue between management host and the connected client host.

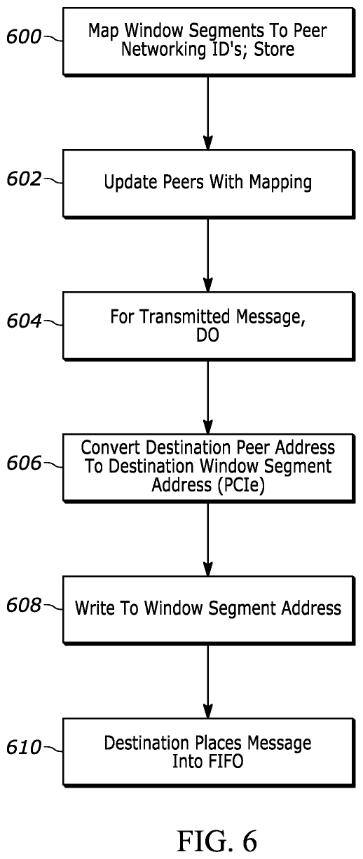

FIG. 6 illustrates the above in flow chart format. Commencing at state 600, each networking endpoint is accorded a networking ID unique in the fabric (locally administered or hard coded). The ID may be, e.g., a MAC address. The window segments in the BAR2 are mapped, e.g., by management software to respective per-peer networking IDs and the mapping is stored, e.g., in hardware at 510 in FIG. 5.

State 602 indicates that, in an example, management software updates all peers with the mappings from state 600. Thus, every peer host has a window segment for it in the other peers participating in the PCIe fabric.

Moving to state 604, for a transmitted message from a transmitting peer to a destination peer, the logic moves to state 606 to convert the destination peer address to the corresponding destination window segment address identified from the mapping at state 600, effectively converting an Ethernet-type MAC address to a PCIe fabric window address. The logic at state 606 may be executed by the DMA engine 410 of the transmitting peer as it is processing a transmit queue descriptor.

At state 608 the message is written, e.g., by the DMA engine, to the PCIe fabric window address. State 610 indicates that on the destination peer endpoint 304, a messaging frame that arrives at a window segment from the remote peer is put into the RX FIFO 514 by the DMA engine of the destination peer endpoint. As part of this, the DMA engine identifies the next RXQ pointer and performs direct mapping access (DMA) of the entry in the FIFO 514 to the RXQ buffer 508 in the local host upstream, generating an interrupt event for receive.

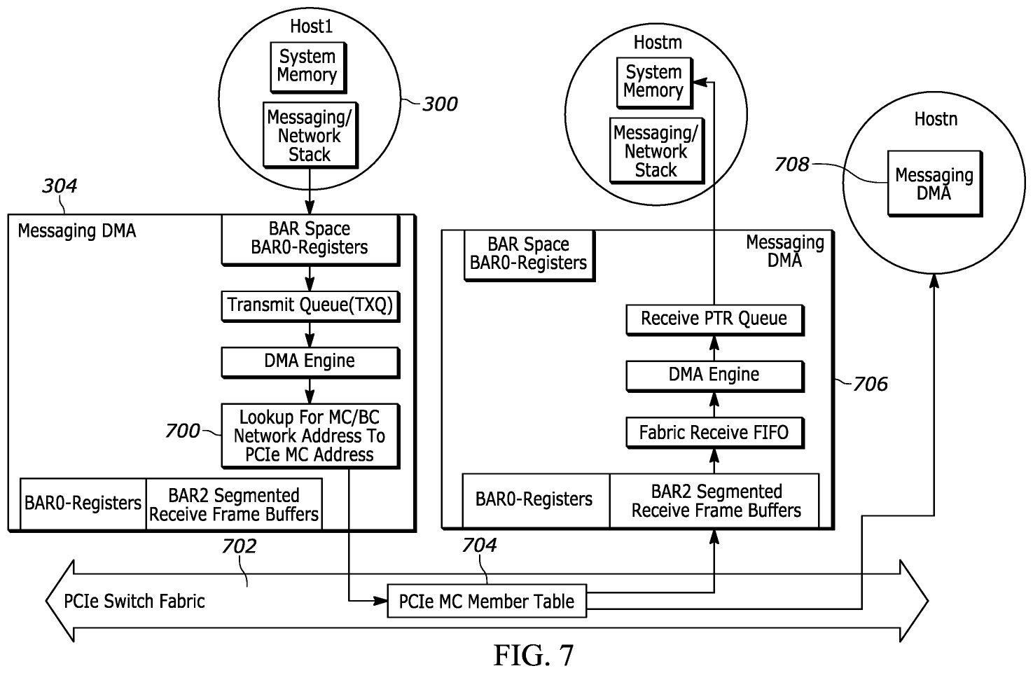

FIG. 5 illustrates unicast packet delivery from one source peer to one destination peer system, while FIG. 7 illustrates a multicast or broadcast packet delivery from one peer to multiple destination peers in the PCIe fabric. Note that for broadcast instead of multicast, substantially the same principles apply, by adding all the destinations to a multicast group and dedicating it as a broadcast group.

In FIG. 7, the components of the transmitting and destination endpoints 304 are substantially the same as in FIG. 5, with the following exceptions. A data structure such as a lookup table 700 correlates (or maps) a networking multicast/broadcast address to a respective PCIe multicast address, which may be done by the management software which in turn keeps client hosts updated of the mapping. The address of a multicast/broadcast message is translated, e.g., by the sending side DMA engine, using the mapping to an equivalent PCIe multicast address. To join a multicast group, an endpoint's receive window segment is added to PCIe multicast range for that multicast group.

Also, the PCIe fabric 702 through which the messages travel from one peer to another includes one or more switches 704 that distribute a multicast packet to its members according to a member table in the switch, thereby handing off a copy of a packet to each of the endpoints 706, 708 in that multicast group as illustrated in FIG. 7. PCIe switches implement this packet replication and giving of copies to members is as per PCI-SIG specifications for PCIe. The PCIe fabric executes the PCIe standard for final packet delivery to destinations.

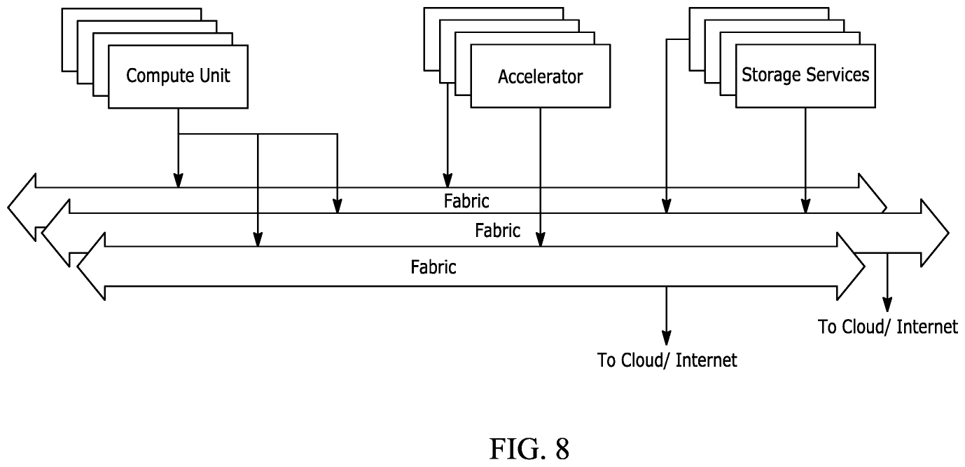

FIG. 8 illustrates an example gaming data center. Each rack of servers includes compute servers, accelerator units (GPUs, DPUs, FPGAs, Video processing, AI inference/ML hardware), and storage services/servers. All these are connected by multiple fabrics (one or two or three, typically; as an example, one ethernet fabric, one PCIe fabric, one storage networking fabric), and most fabrics connect multiple racks and even connect to outside world through internet.

While the particular embodiments are herein shown and described in detail, it is to be understood that the subject matter which is encompassed by the present invention is limited only by the claims.

What is claimed is:

1. A method comprising:
mapping window segment addresses in a basic address register (BAR) to respective peer networking IDs to establish a mapping;
storing the mapping;
updating, with the mapping, peers in a peer-to-peer network configured for communicating with each other over a peripheral computer interconnect express (PCIe);
for a message to be sent from a transmitting peer to a destination peer, converting a network ID in the message to a corresponding destination window segment address using the mapping;
writing the message to the corresponding destination window segment address;
at the destination peer, placing the message from the corresponding destination window segment address into a receiving first in first out (FIFO) storage for further processing.

2. The method of claim 1, comprising identifying a next receive queue pointer and performing direct mapping access (DMA) of the message in the FIFO storage to the receive queue.

3. The method of claim 2, comprising generating an interrupt event for receiving the message.

4. The method of claim 1, wherein the BAR comprises a BAR2.

5. The method of claim 1, wherein the mapping is stored in hardware of a fabric interface endpoint of the transmitting peer.

6. The method of claim 1, wherein the converting is executed during processing a transmit queue descriptor.

7. A computer simulation streaming system comprising:
at least a transmitting peer and a destination peer configured to communicate with each other through respective messaging direct memory access (DMA) endpoints through a peripheral computer interconnect express (PCIe) fabric;
the endpoint of the transmitting peer comprising at least one basic address register (BAR) memory mapped register space, at least one respective transmit descriptor queue (TXQ), at least one segmented memory window in BAR, and at least one direct mapping access (DMA) engine configured for controlling messages through the endpoint, and at least one data structure stored in hardware of the endpoint to map media access code (MAC) addresses to respective PCI memory windows of the destination peer;
the endpoint of the destination peer comprising at least one receive buffer queue (RXQ), at least one segmented memory window in BAR, and at least one DMA engine configured for controlling messages through the endpoint; wherein
the DMA engine of the endpoint of the transmitting peer is configured to convert a destination peer address to a destination window segment address using the data structure stored in hardware to write at least a first message to the destination window segment address through the PCIe fabric.

8. The system of claim 7, wherein the DMA engine is configured to use transmission layer packet (TLP) to write the first message to the destination window segment address.

9. The system of claim 7, wherein the DMA engine of the endpoint of the destination peer is configured to store the first message in a receive first in first out (Rx FIFO).

10. The system of claim 9, wherein the DMA engine of the endpoint of the destination peer is configured to use a receive queue (RXQ) pointer to execute DMA of the first message from the Rx FIFO to a buffer identified by the RXQ pointer.

11. The system of claim 10, wherein the DMA engine of the endpoint of the destination peer is configured to generate an interrupt event for receiving the first message.

12. A device comprising:
at least a first computerized peer;
at least a first direct mapping address (DMA) endpoint communicatively coupling the first computerized peer to at least one peripheral computer interconnect express (PCIe) fabric, the DMA endpoint comprising at least one host side network interface and at least one fabric side network interface with at least one DMA engine therebetween;
the DMA endpoint being configured for switching based on PCIe memory addresses associated with destination endpoints converted from network addresses instead of switching based on respective networking addresses of destination endpoints.

13. The device of claim 12, wherein at least one of the network interfaces comprises an ethernet style interface.

14. The device of claim 12, wherein at least one of the network interfaces comprises a basic address register (BAR) as a window into the endpoint.

15. The device of claim 14, wherein the BAR comprises a BAR0.

16. The device of claim 14, wherein the BAR comprises a BAR2.

17. The device of claim 14, wherein the BAR comprises a BAR4.

18. The device of claim 12, wherein the endpoint comprises at least one data structure in hardware that correlates media access code (MAC) addresses to respective PCIe memory windows.

19. The device of claim 18, wherein multiple hosts can write to one PCIe memory window with writes queued in at least one first in first out (FIFO) buffer.
